(19) United States
(12) Patent Application Publication
(10) Pub. No.: US 2010/0214614 A1
(43) Pub. Date: Aug. 26, 2010

(54) Context-aware printing method and system

(76) Inventors: Andrew Rodney Ferlitsch, Camas, WA (US); James E. Owen, Vancouver, WA (US)

Correspondence Address: SHARP LABORATORIES OF AMERICA, INC., 1320 PEARL ST., SUITE 228, BOULDER, CO, 80302, US

(21) Appl. No.: 12/380,025

(22) Filed: Feb. 23, 2009

(51) Int. Cl. G06K 15/02

(52) U.S. Cl. 358/1.18

(57) ABSTRACT

A context-aware printing method and system invoke contextual rendering tags to realize more flexible printing. The contextual rendering tags provide information about the nature or purpose of print elements in a document and are used to identify and selectively modify print elements in a given print instance of the document at the discretion of the user. The contextual rendering tags provide added flexibility in printing by enabling a user to make a broad array of purpose-driven modifications and enabling a document to be printed in multiple instances and in any sequence with modifications indicated by all contextual rendering tags, modifications indicated by a subset of contextual rendering tags or no context-based modifications. For example, print elements that are designated nonessential by contextual rendering tags can be excluded from a printed document in a first print instance to reduce ink consumption and included in a printed document in a second print instance where an unaltered document is required.

### BACKGROUND OF THE INVENTION

The present invention relates to flexible printing and, more particularly, to a printing method and system that invoke contextual rendering tags to tailor printed documents to specific user purposes.

Users of printing devices often want to modify the text and images on printed documents to suit their specific purposes. It is known, for example, to modify the text and images on a printed document to reduce the amount of ink used to print the document and save costs and resources. Two examples of reduced ink printing are economy printing and “green” printing. In economy printing, a primary objective is to reduce printing costs. In green printing, a main goal is to conserve environmental resources. Another user modification routinely made to text and images on printed documents is “all text to black,” which changes the composition of ink used to print the document to enhance the visibility of certain print elements at the expense of color fidelity.

Known printing methods and systems that support user modification of text and images on printed documents sometimes invoke non-contextual rendering tags. Non-contextual rendering tags specify a predetermined processing to be performed on pixels in a printed document. For example, a non-contextual rendering tag may indicate whether a pixel should be color-corrected using bright or dull colors. In another example, in a scanned document, a non-contextual rendering tag may indicate whether a pixel is a background or foreground pixel, where background pixels are half-toned less sharply than foreground pixels. While non-contextual rendering tags instruct as to a predetermined processing to apply to a pixel, they do not provide information about the original context of a print element that would afford a user greater flexibility in modifying a printed document.

Moreover, in known printing methods and systems that support user modification of text and images on printed documents, the modifications are made at rendering time. This requires special code in the rendering code to make the changes, and the changes become irreversible once the document is printed in a first instance. For example, if a document is printed with ‘all text to black’ and the resulting print file is saved in a document management system, any subsequent printout of the print file would not be able to recover the original color of the text.

### SUMMARY OF THE INVENTION

The present invention provides a context-aware printing method and system that invoke contextual rendering tags to realize more flexible printing. The contextual rendering tags of the present invention provide information about the original context (e.g. nature or purpose or type of graphic) of print elements in a document and are used to identify and selectively modify print elements in a given print instance of the document at the discretion of the user. The contextual rendering tags provide added flexibility in printing by enabling a user to make a broad array of purpose-driven modifications and enabling a document to be printed in multiple instances and in any sequence with modifications indicated by all, a subset or no contextual rendering tags. For example, print elements that are designated nonessential by contextual rendering tags can be excluded from a printed document in a first print instance to reduce ink consumption and included in a printed document in a second print instance where an unaltered document is required.

In one aspect of the invention, a context-aware printing method comprises the steps of receiving document data having context data, generating using the context data one or more contextual rendering tags, storing the contextual rendering tags in association with the document data, receiving a first print instruction and one or more associated context filters, identifying using the context filters and the contextual rendering tags one or more print elements within the document data and printing using the document data a first printed document wherein the identified print elements are modified based on the contextual rendering tags.

In some embodiments, the identified print elements are printed using a reduced amount of ink.

In some embodiments, the identified print elements are unprinted.

In some embodiments, the identified print elements are printed using a different composition of ink.

In some embodiments, the identified print elements are printed at a different location, and/or size, on the first printed document.

In some embodiments, the method further comprises the steps of receiving after the first print instruction a second print instruction and printing using the document data a second printed document wherein the identified print elements are printed without resort to the contextual rendering tags.

In some embodiments, the method further comprises the steps of generating one or more non-contextual rendering tags, storing the non-contextual rendering tags in association with the document data, receiving a print selection mode indication associated with the first print instruction and identifying using the print selection mode indication and the non-contextual rendering tags one or more additional print elements within the document data, wherein the additional print elements are modified based on the non-contextual rendering tags.

In some embodiments, the contextual rendering tags each identify a print element type.

In some embodiments, the print element type is one of banner advertisement, site search, site navigation, hyperlink, plaintext, bitmap, flash, site information, body background, page background or legal notice.

In some embodiments, the contextual rendering tags each address a single pixel.

In some embodiments, the contextual rendering tags are stored in one of a raster data bit-plane, raster data metadata, page description language (PDL) comments, portable document format (PDF) object data or display list (DL) comments.

In some embodiments, the identifying step comprises identifying pixels associated with the identified print elements using the context filters and the contextual rendering tags.

In another aspect of the invention, a printing node comprises a processor communicatively coupled with an interface and a memory, wherein document data having context data received on the interface are transmitted to the processor in response to which the printing node under control of the processor generates using the context data and stores in the memory in association with the document data one or more contextual rendering tags, and wherein in response to receiving a first print instruction associated with one or more context filters the printing node under control of the processor identifies using the context filters and the contextual rendering tags one or more print elements within the document data and prints using the document data a first printed document wherein the identified print elements are modified based on the contextual rendering tags.

In some embodiments, after receiving the first print instruction and in response to receiving a second print instruction the printing node under control of the processor prints using the document data a second printed document wherein the identified print elements are printed without resort to the contextual rendering tags.

In yet another aspect of the invention, a reduced ink printing method comprises the steps of receiving document data having a reference to an advertisement delivery domain, generating using the reference one or more rendering tags identifying an advertisement within the document data, storing the rendering tags in association with the document data, receiving a first print instruction and an associated advertisement filter, identifying using the advertisement filter and the rendering tags the advertisement and printing using the document data a first printed document without the advertisement.

In some embodiments, the method further comprises the steps of receiving after the first print instruction a second print instruction and printing using the document data a second printed document with the advertisement.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a networked printing system.

FIG. 2 shows a client node in some embodiments of the invention.

FIG. 3 shows a printing node in some embodiments of the invention.

FIG. 4 shows elements involved in generating pre-raster document data on a client node in some embodiments of the invention.

FIG. 5 shows an exemplary document in some embodiments of the invention.

FIG. 6 shows elements involved in generating raster document data on a printing node in some embodiments of the invention.

FIG. 7 shows elements involved in generating modified raster document data on a printing node in some embodiments of the invention.

FIG. 8 shows contextual rendering tag generation and storing steps of a context-aware printing method performed on printing node 130 in some embodiments of the invention.

FIG. 9 shows context rendering tag consultation and printing steps of a context-aware printing method performed on printing node 130 in some embodiments of the invention.

### DETAILED DESCRIPTION OF A PREFERRED EMBODIMENT

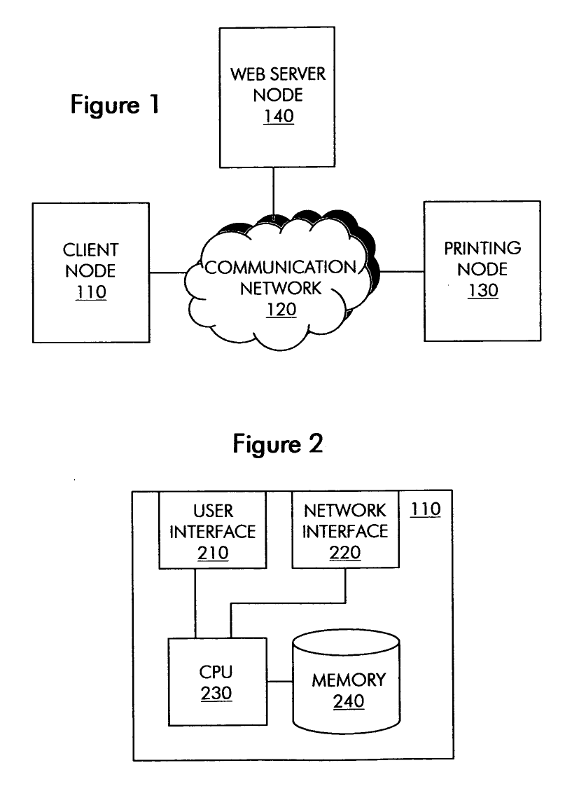

In FIG. 1, a networked printing system is shown in which context-aware printing methods and systems are operative in some embodiments of the invention. The printing system includes a client node 110 communicatively coupled with a printing node 130 and a web server node 140 over a communication network 120. Client node 110 is a computing device, such as a personal computer (PC), workstation, cellular phone, personal data assistant (PDA), Internet PC, or cable set-top box (STB), that is capable of receiving on a user interface print-related requests, such as requests to file or file and print a web page downloaded from web server node 140, and generating and transmitting via a network interface, such as a wired or wireless local area network (LAN), wide area network (WAN) interface, universal serial bus (USB) interface or cellular interface, pre-raster document data conformant with the print-related requests for processing on printing node 130. A web page is a hosted document that is addressable using a Uniform Resource Locator (URL) and downloadable via a traditional Internet connection or another consumer, government or academic network connection, such as a cable television connection. Communication network 120 is a data communication network that in a preferred embodiment traverses the Internet and includes one or more LANs, WANs, wireless metropolitan area (WiMAX) networks, ad-hoc networks and/or other networks each having one or more data communication nodes, such as switches and routers, that operate to communicatively couple client node 110, printing node 130 and web server node 140. In some embodiments, communication network 120 also includes one or more print server nodes that act as intermediaries between client node 110 and printing node 130 in print-related processing. Printing node 130 is a computing device having a network interface, such as a wired Ethernet interface, wireless interface or USB interface, that is capable of receiving pre-raster document data from client node 110, processing the pre-raster document data, storing document data, and printing in one or more instances a hard copy of a document that is the subject of the document data.

In FIG. 2, client node 110 is shown in more detail. Client node 110 has a user interface 210, a network interface 220 and a memory 240, all of which are communicatively coupled with a processor (CPU) 230. User interface 210 has an input mechanism, such as a keyboard, keypad, touch-sensitive navigation tool or voice recognition interface for accepting inputs from a user and an output mechanism, such as a liquid crystal display (LCD), light emitting diode (LED) display, cathode ray tube (CRT) or electronic ink (eInk) display for displaying outputs to a user. Network interface 220 is a wired or wireless data communication interface, such as a wired or wireless LAN or WAN interface, USB port or cellular interface, that communicatively couples client node 110 to communication network 120. Memory 240 includes one or more random access memories (RAM) and one or more read only memories (ROM). An operating system installed in memory 240 and executed by processor 230 manages and executes application software on client node 110, such as a web browser and printer driver, or a direct submit application (DSA), which perform various tasks. In some embodiments, these tasks include processing print-related requests received on user interface 210, determining settings appropriate for the print-related requests and generating and transmitting via network interface 220 pre-raster document data conformant with the print-related requests. Pre-raster document data in some embodiments are PDL data that include text and graphics to be printed, instructions on how the text and graphics are to be printed, and selected settings. Pre-raster document data may on printing node 130 be thereafter rasterized into raster document data, stored, and printed in hard copy format in one or more instances. In other embodiments, such as “direct print” embodiments, pre-raster document data includes a document in a native format and printing node 130 has responsibility for converting the document into PDL data.

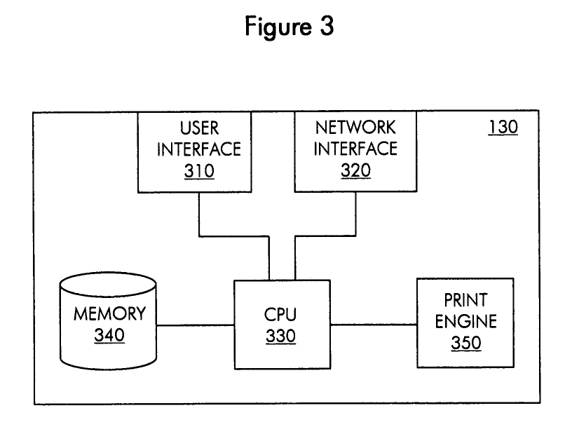

In FIG. 3, printing node 130 is shown in more detail. Printing node 130 may be a multifunction peripheral (MFP) that supports multiple functions, such as printing, foxing, filing, publishing, format conversion, language translation, scanning and copying, or may support a more limited feature set. Printing node 130 has a user interface 310, such as a front panel, for accepting inputs from walk-up users and displaying outputs to walk-up users. The user input device may be a keyboard, keypad or LCD touch screen, for example. Printing node 130 also has a network interface 320. Network interface 320 is a wired or wireless data communication interface, such as a wired or wireless LAN or WAN interface or USB port, that communicatively couples printing node 130 to communication network 120. Internal to printing node 130, interfaces 310, 320 are communicatively coupled with a processor (CPU) 330, a print engine 350 and a memory 340, which may include one or more RAM and ROM storage facilities. Print engine 350 includes printer logic, such as an integrated circuit (IC), and a mechanical section for performing printing functions. For example, print engine 350 may have a liquid ink jet head mounted on a movable carriage or a dry ink (e.g. toner) fusing system for printing documents under the control of a printer IC.

Processor 330 manages and executes software on printing node 130, such as print controller software, which performs various tasks. Tasks include processing print-related requests received on user interface 310 or network interface 320 respecting documents, such as web pages downloaded from web server node 140. Processing print-related requests in some embodiments includes converting pre-raster document data received on network interface 320 into raster document data, storing the raster document data in memory 340 and converting the raster document data into modified raster document data for outputting by print engine 350. In some embodiments, software executed by processor 330 includes firmware.

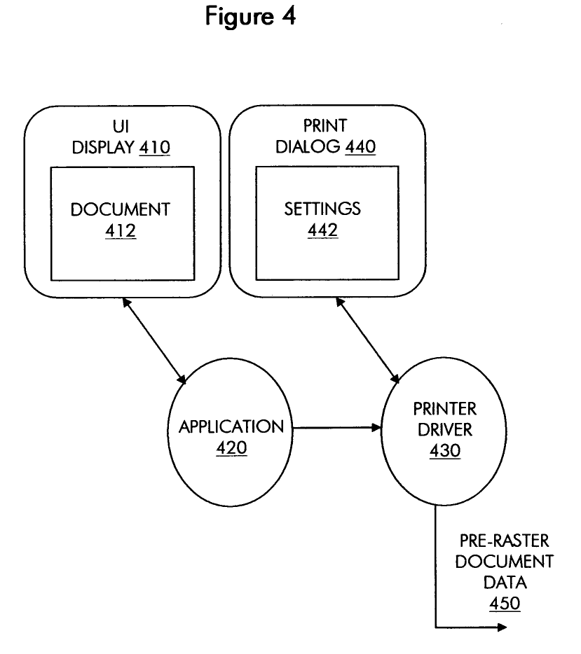

FIG. 4 shows elements involved in generating pre-raster document data 450 on client node 110 in some embodiments of the invention. In operation, a user initiates on a user interface display 410 of user interface 210 a request to file or file and print a document 412, such as a web page downloaded from web server node 140, that the user is viewing under control of an application 420, such as a web browser running on processor 230. In response, application 420 invokes a printer driver 430 which presents on user interface 210 a print dialog 440 displaying settings 442. The user at that point has the option to modify default settings to produce new settings and sends to printer driver 430 a print-related request under the selected settings. The user initiates invoking application 420 to convert document 412 into graphical primitives understood by printer driver 430, such as Microsoft Graphical Device Interface (GDI) or Microsoft XML Paper Specification (XPS) primitives, then converts the graphical primitives into pre-raster document data 450 compatible with printing node 130 and conformant with the selected settings. Printer driver 430 then transmits pre-raster document data 450 via network interface 220 for receipt and processing by printing node 130. Pre-raster document data 450 may be formatted in a PDL, such as Printer Command Language (PCL) 5/6 or Postscript.

In other embodiments, printer driver 430 may perform the process of generating raster data compatible with printing node 130, by converting the pre-raster document data 450 into raster document data (not-shown) compatible with printing node 130 and conformant with the selected settings.

In other embodiments, client node 110 has a DSA for submitting documents to printing node 130 in a native format. In these embodiments, the DSA transmits via network interface 220 pre-raster document data in a native format [e.g. a web page in Hypertext Markup Language (HTML), Cascading Style Sheet (CSS), Extensible Hypertext Markup Language (XHTML) and/or Javascript] along with selected settings. If printing node 130 supports the native format, printing node 130 converts the natively formatted pre-raster document data and processes the document. If printing node 130 does not support the native format, the transmission may be sent directly to a print server or redirected by printing node 130 to an external service for conversion prior to being processed by printing node 130.

In still other embodiments, the DSA transmits to printing node 130 a reference to a document (e.g. a URL of a web page) and the selected settings and printing node 130, alone or in combination with an external conversion service, is responsible for generating pre-raster document data and processing the document.

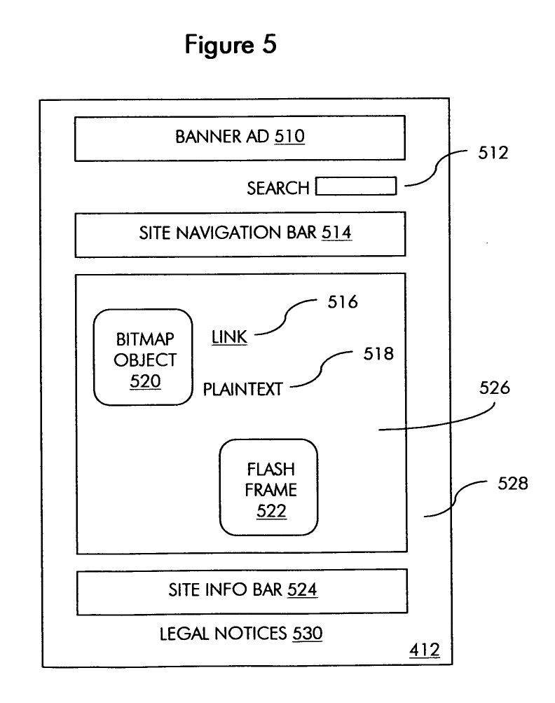

Turning to FIG. 5, document 412, which is the subject of pre-raster document data 450, is shown to include print elements that are nonessential, including a banner advertisement 510, a site search element 512, a site navigation bar 514, a hyperlink 516, a plaintext element 518, a bitmap object 520, a flash frame 522, a site information bar 524, body background 526, page background 528 and legal notices 530. These nonessential print elements may be identified as such by context data found in pre-raster document data 450. By way of example, in a HTML document, banner advertisement 510 may be recognized by a hyperlink around an object that makes reference to a known banner advertisement delivery domain (e.g. googlesyndication.com). Site search element 512 may be recognized by a form box with keywords relating to search appearing near the top of document 412. Site search element 512 may also contain known Google references if implemented as a Google service. Site navigation bar 514 may be recognized by a plurality of buttons near the top of document 412 that activate a hyperlink. Hyperlink 516 may be recognized by a hyperlink around an object. Plaintext 518 may be recognized as text without HTML tags that would indicate a purpose other than plain text. Bitmap object 520 may be recognized by an object or related tag that indicates inclusion of a binary formatted object. Flash frame 522 may be recognized by an object or related tag that indicates inclusion of a flash object [e.g. Shockwave Flash (.swf)]. Site information bar 524 may be recognized by characteristic text strings (e.g. about, terms of use, privacy) encapsulated in hyperlinks. Body background 526 may be recognized as an HTML <body> section whose format may be altered by the CSS background or a class or ID attribute associated with the <body> section. Page background 528 may be recognized as one or more outer <div> sections that span the presumed horizontal viewable area of a web browser (e.g. 800 to 1150 pixels). Legal notices 530 may be recognized by characteristic text strings (e.g. copyright) appearing near the bottom of document 412.

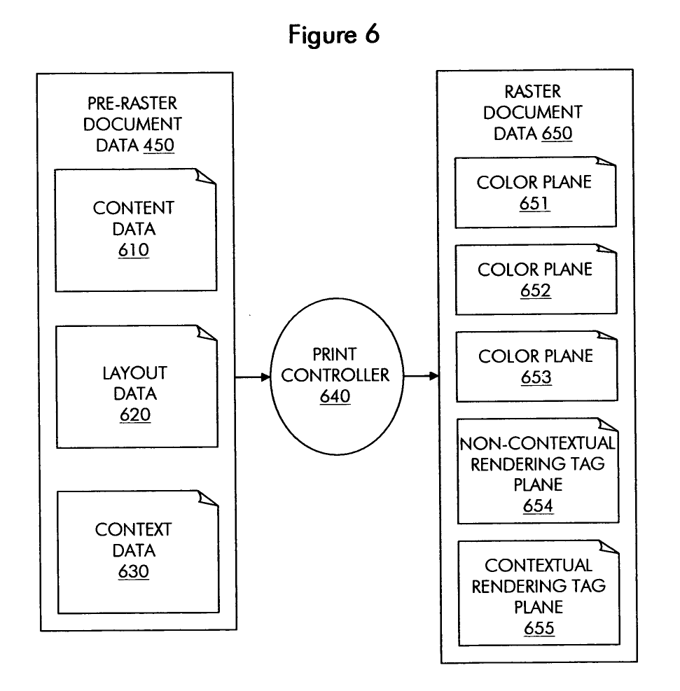

FIG. 6 shows elements involved in generating raster document data 650 on printing node 130 in some embodiments of the invention. Pre-raster document data 450 received on network interface 320 include content data 610, layout data 620 and context data 630. Content data 610 include print elements to be displayed on a printed document, layout data 620 that informs how to display the print elements on the printed document and context data 630 that informs as to print element types. A print controller 640 running on processor 330 uses the context data 630 to identify nonessential print elements in content data 610 and generate and store in memory 340 in association with raster document data 650 contextual rendering tags for such print elements. For example, print controller 640 may tag a print element as a banner advertisement if the source of the print element (e.g. <img src= . . . ) has a reference to a known advertisement delivery domain (e.g. googlesyndication.com). Raster document data 650 may be stored temporarily, semi-permanently or permanently. For example, raster document data 650 may be written to a file (e.g. print to file) or stored in filing storage (e.g. filing job).

In the illustrated example, raster document data 650 includes three color planes 651, 652, 653 corresponding to red, green and blue (RGB), wherein each pixel is represented in each plane by an 8-bit value. Raster document data 650 also includes a non-contextual rendering tag plane 654 wherein each pixel is represented by a single bit that indicates whether the pixel is a foreground or background pixel. For example, a bit value of “1” may indicate that the pixel is a foreground (e.g. text) pixel that should be half-toned more sharply and a bit value of “0” may indicate that the pixel is a background pixel (e.g. fill) that should be half-toned less sharply. Raster document data 650 further includes a contextual rendering tag plane 655 wherein each pixel is represented by a contextual rendering tag that indicates a print element type to which the pixel pertains. In the simplest example, the contextual rendering tag is a single-bit value that indicates whether the pixel is associated with a print element that is nonessential (e.g. “1”) or essential (e.g. “0”). In other examples, the contextual rendering tag is a multi-bit value that provides more detailed information about the print element type to which the pixel pertains (e.g. banner advertisement, flash frame, etc.) thus allowing for selective filtering of nonessential print elements based on type.

In other embodiments, raster document data generated and stored by a print controller includes color planes corresponding to cyan, magenta, yellow (CYM) or cyan, magenta, yellow and black (CYMK).

In other embodiments, raster document data generated and stored by a print controller is segmented into tiles, wherein each tile has a header with metadata relating to the tile, and wherein the contextual rendering tags are included in the metadata. The tiles may be of the same or different geometries and/or sizes.

In still other embodiments, a print controller stores contextual rendering tags in association with pre-raster document data. For example, the print controller may store the contextual rendering tags in PDL comments that precede, follow, or encapsulate the PDL document data that the tags are associated with. Or the print controller may store the contextual rendering tags as additional object data within PDL document data, where the location and tagging of the object data are stored with the object reference in the object catalog. Or the print controller may store the contextual rendering tags in DL comments that precede, follow, or encapsulate DL document data that the tags are associated with.

In other embodiments, a print driver on a client node, rather than a print controller on a printing node, may perform the steps of generating and storing contextual rendering hints in association with document data.

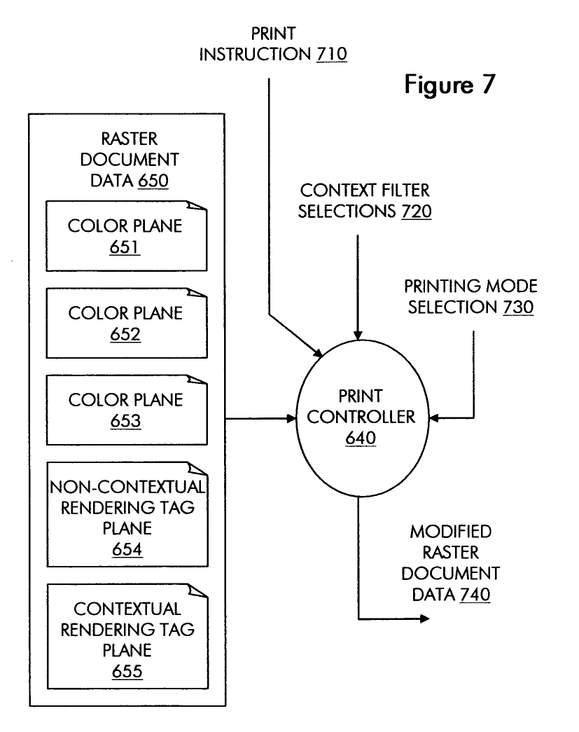

FIG. 7 shows elements involved in generating modified raster document data 730 on printing node 130 in some embodiments of the invention. Print controller 640 generates and transmits to print engine 350 for outputting modified raster document data 740 in response to a print instruction 710, context filter selections 720 and a printing mode selection 730. Print instruction 710 is an instruction from a user to output document 412 in hardcopy format. Print instruction 710 may accompany pre-raster document data 450 received via network interface 320 or may be received at a later time via user interface 310 or network interface 320. Context filter selections 720 are instructions from a user associated with print instruction 710 to consult contextual rendering tags and print elements that match the selected context filters to produce modified raster document data 740. In the simplest example, each contextual rendering tag is a single-bit value that indicates whether a pixel is associated with a print element that is essential or nonessential, for that specific instance of a print job, and a single context filter indicates to include or exclude (e.g. white-out from the printed document) all pixels that are associated with nonessential print elements. In a more complex example, a contextual rendering tag is a multi-bit value that provides information about the print element type to which a pixel pertains (e.g. banner advertisement, flash frame, etc.) and one or more context filters indicate which print element types to include and exclude from the printout. For example, a single context filter may instruct to remove all banner advertisements, in which case pixels whose contextual rendering tags indicate they are part of a banner advertisement are whited-out while pixels whose context-based rendering tags indicate they are part of another nonessential print element type are inked. In other embodiments, a context filter may indicate means of reducing the amount of ink used by a print element type without eliminating the print element type. For example, a pixel may be converted from color to black-and-white or the intensity value of the pixel may be reduced. More generally, context filters and contextual rendering tags may be used to effect various user-selected modifications to print elements in a given instance of a printed document, such as exclusion (e.g. whiting-out) of a print element, reduction of the ink used to print a print element, increase in the ink used to print a print element, change in composition of ink used to print a print element, change in positioning of a print element on a printed document, or change in the size of a print element on a printed document, just to name a few examples. With regard to a change in positioning of a print element on a printed document, it may be desirable if a print element is excluded from a given instance of a printed document to shift another print element into the space vacated by the excluded print element in the interest of saving paper. Printing mode selection 730 is an instruction from a user to consult non-contextual rendering tags and reduce ink consumed by pixels based on the non-contextual rendering tags. In one example, a non-contextual rendering tag is a single-bit value that indicates whether a pixel is a foreground or background pixel and a single print mode selection indicates to reduce or not the ink used to print the pixel by a predetermined amount. More particularly, when printing mode selection 730 indicates to print in an economy mode the ink used to print a foreground pixel may be reduced by approximately 50% by dropping the most significant bit and the ink used to print a background pixel may be reduced by approximately 75% by dropping the first and second most significant bits. On the other hand, when printing mode selection 730 indicates to print in a normal mode, the most significant bits are not dropped. Print instruction 710, context filter selections 720 and printing mode selection 730 may be received on user interface 310 or via network interface 320 and may be either bundled with or received independently of each other and of pre-raster document data 450.

Raster document data 650 are retained in memory 340 after document 412 is printed in a first instance so that upon receiving a second print instruction with the same or different selections additional hard copies of document 412 can be printed. For example, a user can in a first instance print an informal copy of document 412 in which contextual rendering tags are invoked to exclude nonessential print elements, and in a second instance print a formal copy of document in which contextual rendering tags are not invoked and nonessential print elements are included.

In some embodiments, before printing the document a thumbnail is output on user interface 310 of printing node 130 or returned to client node 110 and output on user interface 210 so that the user can preview the document and, if unsatisfactory, abort the print instruction.

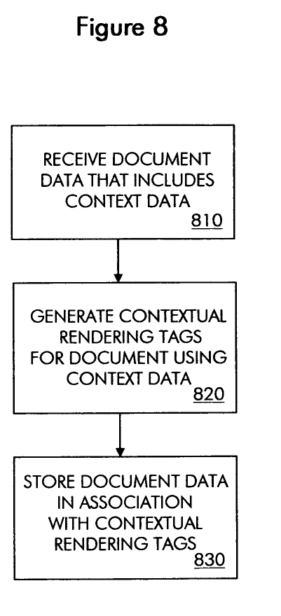

FIG. 8 shows contextual rendering tag generation and storing steps of a context-aware printing method performed on printing node 130 in some embodiments of the invention. Printing node 130 receives document data that includes context data (810). Printing node 130 then generates contextual rendering tags for the document using the context data (820) and stores the document data in association with the contextual rendering tags (830).

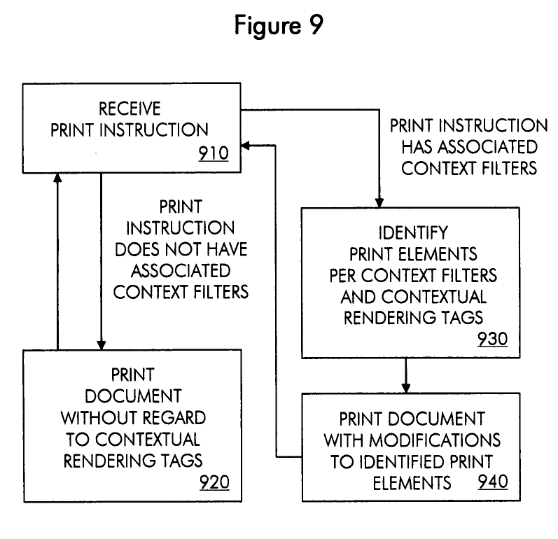

FIG. 9 shows contextual rendering tag consultation and printing steps of a context-aware printing method performed on printing node 130 in some embodiments of the invention. Printing node 130 receives a print instruction for a document that is the subject of document data stored in association with contextual rendering tags (910). As mentioned, the initial print instruction may accompany the document data, in which case processing of the initial print instruction is deferred until the contextual rendering tags have been generated and stored in association with the document data. If the print instruction does not have associated context filters, printing node 130 prints the document without regard to the contextual rendering tags (920) and awaits the next print instruction (910). If the a print instruction has associated context filters, printing node 130 consults the contextual rendering tags in light of the context filters to identify print elements to be modified in the printout (930), prints the document with the identified print elements modified based on the contextual rendering tags (940) and awaits the next print instruction (910). The context-based modifications made to an identified print element may include, for example, exclusion from the printed document, reducing the ink used to print without eliminating the identified print element altogether, increasing the ink used to print, changing the composition of ink used to print or changing the position on the printed document. Moreover, printing node 130 may consult non-contextual rendering tags to, for example, reduce the ink supplied to background pixels and realize further ink savings.

In the system and method of the present invention, context data for each pixel in a document may include any number of context tags, from zero to N, with each context tag representing a different print element type or attribute. Any one, or multiples, of the context tags can be used by one or more context filters to modify a print job. When printing multiple documents, or multiples of the same document, the invention permits selection of print instructions for each document printed. As a result, each document of a multi-document print job can have its own context-based modification. Because the metadata context tags are stored with a document, it does not matter when, or in what order, documents are printed. Each print job can be selectively modified. In other words, when performing one or more print jobs, each print job can have any combination of context filtering, or no filtering, and they can be submitted to the printing device in any order.

It will be appreciated by those of ordinary skill in the art that the invention can be embodied in other specific forms without departing from the spirit or essential character hereof. For example, while the document to be printed has generally been described and illustrated as an HTML web page, the invention is applicable to various types of documents, such as Microsoft Office documents, Open Office documents and Adobe PDF documents. Moreover, while numerous examples of context data have been provided they are not intended to be exclusive. If the invention is used with Microsoft Office documents, for example, context data for generating suitable contextual rendering tags could be applied to print element types such as Table of Contents, footnotes, headers/footers, vector graphics, highlighted text, editing marks, embedded objects, other graphical elements, and font specific characteristics (color, font, size, and alterations such as bold, italic, superscript, subscript, underlining, and strikeout). Other examples of taggable print elements for use with the present invention will occur to those skilled in the art. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A context-aware printing method, comprising the steps of:
receiving document data having context data;
generating using the context data one or more contextual rendering tags;
storing the contextual rendering tags in association with the document data;
receiving a first print instruction and one or more associated context filters;
identifying using the context filters and the contextual rendering tags one or more print elements within the document data; and
printing using the document data a first printed document wherein the identified print elements are modified based on the contextual rendering tags.

2. The method of claim 1, wherein the identified print elements are printed using a reduced amount of ink.

3. The method of claim 1, wherein the identified print elements are unprinted.

4. The method of claim 1, wherein the identified print elements are printed using a different composition of ink.

5. The method of claim 1, wherein modification of the identified print elements is selected from the group consisting of printing the identified print elements at a different location on the first printed document, and changing the size of the identified print elements on the first printed document.

6. The method of claim 1, further comprising the steps of:
receiving after the first print instruction a second print instruction; and
printing using the document data a second printed document wherein the identified print elements are printed without resort to the contextual rendering tags.

7. The method of claim 1, further comprising the steps of:
generating one or more non-contextual rendering tags;
storing the non-contextual rendering tags in association with the document data;
receiving a print selection mode indication associated with the first print instruction; and
identifying using the print selection mode indication and the non-contextual rendering tags one or more additional print elements within the document data, wherein the additional print elements are modified based on the non-contextual rendering tags.

8. The method of claim 1, wherein the contextual rendering tags each identify a print element type.

9. The method of claim 8, wherein the print element type is one of banner advertisement, site search, site navigation, hyperlink, plaintext, bitmap, flash, site information, body background, page background or legal notice.

10. The method of claim 1, wherein the contextual rendering tags each address a single pixel.

11. The method of claim 1, wherein the contextual rendering tags are stored in one of a raster data bit-plane, raster data metadata, page description language (PDL) comments, portable document format (PDF) object data or display list (DL) comments.

12. The method of claim 1, wherein the identifying step comprises identifying pixels associated with the identified print elements using the context filters and the contextual rendering tags.

13. A printing node, comprising:
a processor;
an interface communicatively coupled with the processor; and
a memory communicatively coupled with the processor, wherein document data having context data received on the interface are transmitted to the processor in response to which the printing node under control of the processor generates using the context data and stores in the memory in association with the document data one or more contextual rendering tags, and wherein in response to receiving a first print instruction associated with one or more context filters the printing node under control of the processor identifies using the context filters and the contextual rendering tags one or more print elements within the document data and prints using the document data a document wherein the identified print elements are modified based on the contextual rendering tags.

14. The printing node of claim 13, wherein after receiving the first print instruction and in response to receiving a second print instruction the printing node under control of the processor prints using the document data a document wherein the identified print elements are printed without resort to the contextual rendering tags.

15. The printing node of claim 13, wherein the contextual rendering tags each identify a print element type.

16. The printing node of claim 15, wherein the print element type is one of banner advertisement, site search, site navigation, hyperlink, plaintext, bitmap, flash, site information, body background, page background or legal notice.

17. The printing node of claim 13, wherein the contextual rendering tags each address a single pixel.

18. The printing node of claim 13, wherein the contextual rendering tags are stored in one of a raster data bit-plane, raster data metadata, PDL comments, PDF object data or DL comments.

19. A reduced ink printing method, comprising the steps of:
receiving document data having a reference to an advertisement delivery domain;
generating using the reference one or more rendering tags identifying an advertisement within the document data;
storing the rendering tags in association with the document data;
receiving a first print instruction and an associated advertisement filter;
identifying using the advertisement filter and the rendering tags the advertisement; and
printing using the document data a first printed document without the advertisement.

20. The method of claim 19, further comprising the steps of:
receiving after the first print instruction a second print instruction; and
printing using the document data a second printed document with the advertisement.
